(19) United States
(12) Patent Application Publication
(10) Pub. No.: US 2023/0164688 A1
(43) Pub. Date: May 25, 2023

(54) METHOD AND SYSTEM FOR MANAGING POWER OF RADIO UNIT (RU)

(71) Applicant: Sterlite Technologies Limited, Gurugram (IN)

(72) Inventors: Nitin Kumar, Gurugram (IN); Manish Jamwal, Gurugram (IN); Gurpreet Singh, Gurugram (IN); Rishi Nandwana, Gurugram (IN)

(73) Assignee: Sterlite Technologies Limited, Gurugram (IN)

(21) Appl. No.: 17/697,304

(22) Filed: Mar. 17, 2022

(30) Foreign Application Priority Data
Nov. 24, 2021 (IN) 202111054198

(51) Int. Cl. H04W 52/02; H04W 52/18

(52) U.S. Cl. CPC H04W 52/0206; H04W 52/18

(57) ABSTRACT

The present disclosure provides a method and a system for managing the power of a radio unit (RU) (130) of a next generation NodeB (gNB) (100) operating in a wireless communication network. The RU comprising a plurality of transmitter and receiver (TRX) radio modules (134) for data processing. The method comprises determining a plurality of user equipment's (UE's) (150) serving a cell associated with said gNB, The method further includes periodically changing power of at least one TRX radio module from said plurality of TRX modules based on the determined plurality of UE's serving said cell associated with said gNB, where said the power of said at least one TRX radio module is periodically changed without shutting down said RU.

### TECHNICAL FIELD

The present disclosure relates to a wireless communication system, and more specifically relates to a power management system and method for a radio unit (RU) of a base station.

### BACKGROUND

Along with the development of communication construction, the number of 5G base stations increases, the demand of base station power consumption is bigger and bigger, especially the increase of 5G base station construction demand to and the power consumption of 5G base station be about 3-4 times of 4G, consequently need carry out energy-conserving control to 5G base station, reduce the power consumption of 5G base station.

For example, the power consumption is very high in case of large no. of Transmission and Receiver (TRX) chains used to support massive multiple-input multiple-output (MIMO) and beamforming, (i.e., 32 TRX, 64 TRX) and it can be in degrees of Kilowatts for FR2 (frequencies). Some of the prior art references are given below:

U.S. Ser. No. 10/979,982B2 discloses systems, apparatuses, and methods for controlling a transmission power of one or more wireless devices. A base station may send, to a wireless device, one or more radio resource control messages comprising power control parameters and/or other wireless resources. The base station may send to the wireless device, activation, or deactivation of a channel state information (CSI) report. The wireless device may adjust, based on one or more of the activation or deactivations, at least one value associated with a transmission power of an uplink channel transmission. The at least one value may comprise one or more correction values associated with the transmission power of the uplink channel transmission. At least one of an uplink data channels or a semi-persistent (SP) CSI report may be dropped. A transmission power of at least one of an uplink data channels or an SP CSI report may be adjusted (e.g., scaled down).

U.S. Ser. No. 10/827,430B2 teaches systems, apparatuses, and methods for controlling power usage in radio access networks. A central unit may be configured to receive, from an element management system, one or more first messages indicating power saving policies. The central unit may determine, based on the power saving policies, an idle period, and may send, to a distributed unit, a second message indicating the idle period. The distributed unit may activate, for the idle period, a power saving mode of the distributed unit.

KR20180014941A discloses a method and apparatus for operating between a terminal and a base station capable of efficiently reducing network power consumption according to a condition of the base station, in a next generation mobile communication system. A method for processing a control signal includes the steps of receiving a first control signal; processing the received first control signal; and transmitting a second control signal to the base station.

While the prior arts cover various solutions for reducing network power consumption, however these solutions are not optimized as O-DU (Open Distributed Unit) and O-CU (Open Central or Centralized Unit) also lose power trying to save O-RU (Open Radio Unit) power. That is, a centralized policies for ideal time/mode are utilized in order to optimize total power of said O-RU resulting in performance degradation of gNB (Next Generation Node-B) due to dependencies on other units (i.e., O-DU and O-CU). In light of the above-stated discussion, there is a need to overcome the above stated disadvantages.

### OBJECT OF THE DISCLOSURE

A principal object of the present disclosure is to provide a method and a system for reducing an active period of a terminal power reduction to save power.

Another object of the present disclosure is to provide the method implemented in an Open-Radio Unit (O-RU). More specifically, the method to lower down the power consumption within the O-RU only.

Yet another object of the present disclosure is to reduce huge power consumption and reduce OPEX (Operating expenses) for the operators.

### SUMMARY

Accordingly, the present disclosure provides a power management method for radio unit (RU) of a next generation NodeB (gNB) operating in a wireless communication network. The RU comprises a plurality of transmitter and receiver (TRX) radio modules for data processing. The method determines a plurality of user equipment's (UE's) served by a cell associated with said gNB. Further, the method periodically changes a power of at least one TRX radio module from said plurality of TRX modules based on determined plurality of UE's serving said cell associated with said gNB, where said power of said at least one TRX radio module is periodically changed without shutting down said RU.

The method for periodically changing said power of said at least one TRX radio module comprises: periodically reducing the power of said at least one TRX radio module, in response to determine that no UE is serving said cell associated with said gNB for a predefined time period.

The method for periodically changing said power of said at least one TRX radio module comprises: periodically increasing said power of said at least one TRX radio module, in response to determine that at least one UE is serving said cell associated with said gNB for said predefined time period.

The method for periodically changing said power of said at least one TRX radio module comprises: calculating a size of a first downlink (DL) data frame to be processed using each of TRX radio module, from said plurality of TRX radio modules, during a first predefined time period, calculating a size of a second downlink (DL) data frame to be processed using each of TRX radio module, from said plurality of TRX radio modules, during a second predefined time period, wherein said second predefined time period is greater than or equal to said first predefined time period and wherein said first downlink (DL) data frame and second downlink (DL) data frame comprises a system information, and periodically changing said power of at least one TRX radio module from said plurality of TRX modules based on said size of said first downlink (DL) data frame and said size of said second downlink (DL) data frame.

The method for periodically changing said power of at least one TRX radio module from said plurality of TRX modules based on said size of said first downlink (DL) data frame and said size of said second downlink (DL) data frame comprises: periodically lowering said power of said at least one TRX radio module when said the size of said first downlink (DL) data frame is equal to said size of said second downlink (DL) data frame.

The method for periodically changing said power of at least one TRX radio module from said plurality of TRX modules based on said size of said first downlink (DL) data frame and said size of said second downlink (DL) data frame comprises: periodically increasing said power of said at least one TRX radio module when said the size of said first downlink (DL) data frame is less than said size of said second downlink (DL) data frame.

The method for periodically changing said power of said at least one TRX radio module by said power management unit comprises: calculating a size of a downlink (DL) data frame to be processed using each of TRX radio module, wherein said DL data frame comprises system information, determining whether said size of DL data frame for each TRX radio module meets a predefined data transmission threshold, and periodically changing said power of said at least one TRX radio module at a predetermined time intervals in response to determining that said size of DL data frame for each TRX module from said plurality of TRX radio modules meets said predefined data transmission threshold.

The method for periodically changing said power of said at least one TRX radio module at said predetermined time intervals in response to determining that said size of DL data frame for each TRX module from said plurality of TRX radio modules meet said predefined data transmission threshold comprises: periodically lowering said power of said at least one TRX radio module at said predetermined time intervals in response to determining that said size of DL data frame for each TRX module from said plurality of TRX radio modules meets said predefined data transmission threshold.

The method for periodically changing said power of said at least one TRX radio module at said predetermined time intervals in response to determining that said size of DL data frame for each TRX module from said plurality of TRX radio modules meet said predefined data transmission threshold comprises: periodically increasing said power of said at least one TRX radio module at said predetermined time intervals in response to determining that said size of DL data frame for each TRX module from said plurality of TRX radio modules fails to meet said predefined data transmission threshold.

The method for periodically changing said power of said at least one TRX radio module at said predetermined time intervals in response to determining that said size of DL data frame for each TRX module from said plurality of TRX radio modules meet said predefined data transmission threshold comprises: restoring the periodically changing said power of at least one TRX radio module at said predetermined time intervals in response to determining that the data is transmitted via any TRX chain is more than said predefined data transmission threshold, the power capping would be remove and all TRX shall be transmitting with normal power

The DL data frame is associated with a user plane function comprising in-phase and quadrature phase (IQ) samples and wherein said system information comprises data associated with at least one of SSB, MIB, SIB-1, PDCCH, and PCH.

A radio unit (RU) of a next-generation NodeB (gNB) operating in a wireless communication network, where said RU comprising a plurality of transmitter and receiver (TRX) radio modules for data processing is disclosed. The RU comprises a connector configured to transmit and receive data between said RU and a distributed unit (DU) and a controller. The controller is configured to determine a plurality of user equipment's (UE's) serving a cell associated with said gNB, and periodically change the power of at least one TRX radio module from said plurality of TRX modules based on the determined plurality of UE's serving said cell associated with said gNB, where said the power of said at least one TRX radio module is periodically changed without shutting down said RU.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 is a view illustrating an O-RAN system according to the present disclosure.

FIG. 2 is a view illustrating a flow in which scheduling and beamforming commands are transmitted through C-plane and U-plane messages according to the present disclosure.

FIG. 3 illustrates a flowchart of a power management method for an O-RU, according to the present disclosure.

FIG. 4 illustrates various hardware elements of said O-RU of a base station, according to the present disclosure.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures, and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Standard networking terms and abbreviation: RAN: a RAN may stand for the radio access network. The radio access network (RAN) may be a part of a telecommunications system that may connect individual devices to other parts of a network through radio connections. The RAN may provide a connection of user equipment (UE) such as mobile phones or computers with the core network of the telecommunication systems. The RAN may be an essential part of the access layer in the telecommunication systems which utilize base stations (such as e node B, g node B) for establishing radio connections.

Active bearer: An active bearer corresponds to tunnel connections between the UE and a packet data network gateway to provide a service.

O-RAN: O-RAN is an evolved version of prior radio access networks, making the prior radio access networks more open and smarter than previous generations. The O-RAN provides real-time analytics that drives embedded machine learning systems and artificial intelligence back end modules to empower network intelligence. Further, the O-RAN includes virtualized network elements with open and standardized interfaces. Open interfaces are essential to enable smaller vendors and operators to quickly introduce their services or enable operators to customize the network to suit their own unique needs. Open interfaces also enable multivendor deployments, enabling a more competitive and vibrant supplier ecosystem. Similarly, open-source software and hardware reference designs enable faster, more democratic and permission-less innovation. Further, the O-RAN introduces a self-driving network by utilizing new learning-based technologies to automate operational network functions. These learning-based technologies make the O-RAN intelligent. Embedded intelligence, applied at both component and network levels, enables dynamic local radio resource allocation and optimizes network-wide efficiency. In combination with O-RAN's open interfaces, AI-optimized closed-loop automation is a new era for network operations.

Quality of Service (QoS) Class identifier (QCI): QCI level corresponds to a QoS value required by an active bearer in the UE to provide the service.

Near real-time RAN Intelligent Controller (Near-RT RIC): Near-RT RIC is a logical function that enables near-real-time control and optimization of O-RAN elements and resources via fine-grained data collection and actions over E2 interface.

Non-Real Time Radio Intelligent Controller (Non-RT-RIC): Non-RT-RIC is a logical function that enables non-real-time control and optimization of RAN elements and resources, AI/ML workflow including model training and updates, and policy-based guidance of applications/features in near-RT RIC. It is a part of the Service Management & Orchestration Framework and communicates to the near-RT RIC using the A1 interface. Non-RT control functionality (>1 s) and near-Real Time (near-RT) control functions (<1 s) are decoupled in the RIC. Non-RT functions include service and policy management, RAN analytics and model-training for some of the near-RT RIC functionality, and non-RT RIC optimization.

O-CU is O-RAN Central Unit, which is a logical node hosting RRC (Radio Resource Control), SDAP (Service Data Adaptation Protocol) and PDCP (Packet Data Convergence Protocol).

O-CU-CP is O-RAN Central Unit—Control Plane, which is a logical node hosting the RRC and the control plane part of the PDCP protocol.

The O-CU-UP is O-RAN Central Unit—User Plane, which is a logical node hosting the user plane part of the PDCP protocol and the SDAP protocol.

O-DU is O-RAN Distributed Unit, which is a logical node hosting RLC/MAC/High-PHY layers based on a lower layer functional split.

O-RU is O-RAN Radio Unit, which is a logical node hosting the Low-PHY layer and RF processing based on a lower layer functional split. This is similar to 3GPP's “TRP” or “RRH” but more specific in including the Low-PHY layer (FFT/iFFT, PRACH extraction).

O1 interface is an interface between management entities in a Service Management and Orchestration (SMO) Framework and O-RAN managed elements, for operation and management, by which FCAPS management, Software management, File management shall be achieved.

xAPP is an independent software plug-in to the Near-RT RIC platform to provide functional extensibility to the RAN by third parties.” The near-RT RIC controller can be provided different functionalities by using programmable modules as xAPPs, from different operators and vendors.

gNB: New Radio (NR) Base stations which have the capability to interface with 5G Core named as NG-CN over NG-C/U (NG2/NG3) interface as well as 4G Core known as Evolved Packet Core (EPC) over S1-C/U interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as an anchor for control plane connectivity to NG-CN.

Standalone NR: It is a 5G Network deployment configuration where gNB does not need any assistance for connectivity to the core network, it can connect by its own to NG-CN over NG2 and NG3 interfaces.

Non-standalone E-UTRA: It is a 5G Network deployment configuration where the LTE eNB requires a gNB as an anchor for control plane connectivity to NG-CN.

Standalone E-UTRA: It is a typical 4G network deployment where a 4G LTE eNB connects to EPC.

Xn Interface: It is a logical interface which interconnects the New RAN nodes i.e., it interconnects gNB to gNB and LTE eNB to gNB and vice versa.

Reference signal received power (RSRP): RSRP may be defined as the linear average over the power contributions (in [W]) of the resource elements that carry cell-specific reference signals within the considered measurement frequency bandwidth.” RSRP may be the power of the LTE Reference Signals spread over the full bandwidth and narrowband.

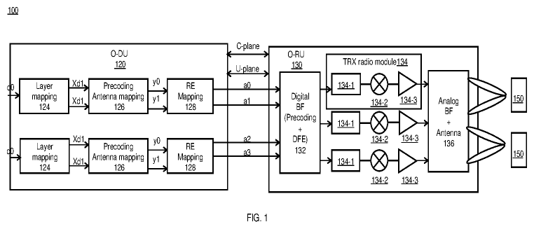

FIG. 1 is a view illustrating an O-RAN (Open-Radio Access Network) system according to the present disclosure.

In a 5G system, power consumption is very high especially in the case of large no. of Transmission and Receiver chains used to support massive MIMO (Multiple Input Multiple Output) and beamforming, (i.e., 32 TRX, 64 TRX). It can be in degrees of Kilowatts for FR2 (frequencies).

C-Plane latency is measured as the time required for a UE (User Equipment) to transit from idle state to active state. In an idle state, the UE does not have an RRC connection.

To facilitate the mobility of heterogeneous networks, the control plane (C-plane) and user plane (U-plane) decoupled architecture is being considered by the fifth generation (5G) wireless communication network, in which relatively crucial C-plane is expanded and kept at dependable lower frequency bands to guarantee transmission reliability and the corresponding U-plane is moved to available higher frequency bands to boost capacity. This architecture is discussed below in detail.

Referring to FIG. 1, the O-RAN is a standard that logically separates the functions of the eNB (Evolved Node B) and gNB (Next Generation Node-B) of the existing 4G and 5G systems, and in the O-RAN standard, an O-DU (Open Distributed Unit) 120 and an O-RU 130 (interchangeably used as RU 130), in an O-RAN gNB (or gNB) 100 are defined. Details regarding the other functions/units (e.g., NRT-RIC, an RIC, an O-CU-CP, an O-CU-UP, etc.,) in said O-RAN gNB 100 are excluded herein (described above) for sake of brevity but should be understood and read in accordance with said O-RAN standard.

The O-DU 120 is a logical node that provides RLC (Radio link control), MAC (Medium Access Control), and higher physical layer (high-PHY) functions, and the O-RU 130 connected to the O-DU 120 is a logical node that provides low-PHY functions and radio frequency (RF) processing. For example, a plurality of O-RUs 130 may be connected to one O-DU 120, and a plurality of O-DUs 120 may be connected to one O-CU-UP (not shown).

The O-RU 130 and O-DU 120 may be connected through a connector i.e., fronthaul (FH) connection. In this case, the O-RU 130 and the O-DU 120 each may perform a function of a physical layer. In a physical layer for downlink (DL) in a 4G or 5G communication system, channel coding and scrambling for received data by receiving downlink data from a media access control (MAC) layer (not shown in FIG) and layer mapping of the modulation symbol is performed at 124 after modulation is performed on the scrambled data. The modulation symbol mapped to each layer is mapped to each antenna port at 126 and is mapped to a corresponding resource element (RE) at 128, resulting in an IQ sampling sequence. Digital beamforming (which can be mixed with precoding) is performed on the modulation symbol at 132, and inverse fast Fourier transform (FFT) (IFFT) is performed to transform the same into a time-domain signal. Thereafter, a cyclic prefix (CP) is added, and the modulation symbol is carried on a carrier frequency in at least one of a transmitter and receiver (TRX) radio module 134 and transmitted to a plurality of user equipments (UE's) 150 through an antenna 136.

The TRX radio module (or TRX module) 134 may include, for example, Digital-to-Analog Converters (DAC) 134-1, a local oscillator (LO) phase shifter 134-2 and a power amplifier (PA) 134-3.

In the case of a large number of TRX radio modules 134, arranged into the O-RU 130 accompanies, a propagation loss of radio waves is decreased and transmission distance is increased. Since, a plurality of TRX radio module 134 is used to support beamforming, massive multiple-input multiple-output (MIMO), full dimensional MIMO (FD-MIMO), array antenna, an analog beam forming, large scale antenna techniques in 5G communication systems.

However, the power consumption of the O-RU 130 is very high due to a large number of TRX radio modules 134 used to support massive MIMO and beamforming, i.e., 32 TRX, 64 TRX. Hence, the present disclosure aims at reducing the power consumption within the O-RU 130.

According to the present disclosure, the O-RU 130 may be configured to determine the plurality of user equipment's (UE's) 150 serving a cell (not shown in FIG) associated with said gNB 100. For example, in the case of a UE 150 is serving the cell or a channel, then accessing the TRX radio modules 134 by said UE 150 is very often i.e., the TRX radio modules 134 are active/in-use state. In other example scenario, in case if the UE 150 is not serving any cell or a channel, then accessing of the TRX radio modules 134 by said UE 150 is very minimal i.e., some of the TRX radio module(s) 134 may be said to be in unused state. For example, when there is no UE 150 served by any particular cell then it is only some common channel and signal i.e., system information that needs to be transmitted in the DL data frame.

Further, the O-RU 130 may be configured to periodically (or iteratively) change power of at least one TRX radio module 134 based on the determined plurality of UE's 150 serving said cell associated with said gNB 100. The power of said at least one TRX radio module 134 is periodically changed without shutting down power, completely, of said O-RU 130.

The change in power of said O-RU 130 is achieved by periodically reducing the power of said at least one TRX radio module 134, in response to determining that no UE 150 is serving said cell associated with said gNB 100 for a predefined time period. The term “periodically” herein indicates that reduction of power is executed periodically in different time intervals. For example, the power of said O-RU 130 may be reduced by ‘a’ dB (configurable, for example—0.5 dB) for the time period “Tx1”. After the time period “Tx2”, the power of said O-RU 130 may be reduced by ‘b’ dB (for example—1 dB). Further, the O-RU 130 may be configured to set a maximum power threshold (i.e., MaxRedPower or MaxIncPower) indicating maximum allowed reduced or increased power. Thus, there will be no complete shutdown of the TRX radio modules 134, as only power will be reduced.

The change in power of said O-RU 130 is achieved by periodically increasing the power of said at least one TRX radio module 134, in response to determining that at least one UE 150 is serving said cell associated with said gNB 100 for said predefined time period.

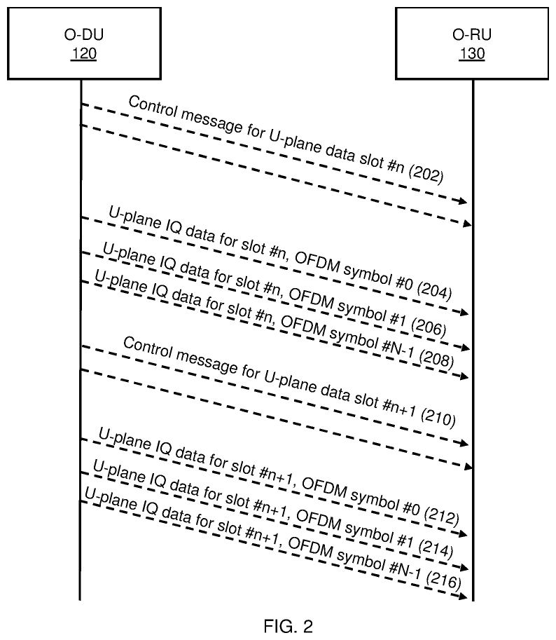

FIG. 2 is a view illustrating a flow in which scheduling and beamforming commands are transmitted through C-plane and U-plane messages according to the present disclosure.

Referring to FIG. 2, information transmitted between the O-RU 130 and the O-DU 120 will be described in more detail. The O-RU 130 and the O-DU 120 are connected by the connector i.e., FH interface, optical cable or a coaxial cable, or an ethernet.

In general, there are four types of information to be transmitted from the O-DU 120 of option 7-2× to the O-RU 130. Information transmitted from a management-plane (M-plane) is transmitted in both directions of DL (Downlink) and UL (Uplink) by non-real-time transmission and is information for initial configuration or reconfiguration (or reset) between the O-DU 120 and O-RU 130. The M-plane of a networking device is the element within a system that configures, monitors, and provides management, monitoring and configuration services to, all layers of the network stack and other parts of the system. Information transmitted in a synchronization-plane (the S-plane) is transmitted in real-time and is information for synchronizing or timing synchronization between the O-DU 120 and the O-RU 130. Information transmitted in a control-plane (C-plane) is transmitted in the DL direction by real-time transmission and is information for the O-DU 120 to transmit a scheduling and/or beamforming command to the O-RU 130. Information transmitted from a U-plane (user-plane) is transmitted in both directions of DL and UL by real-time transmission. DL frequency domain in-phase and quadrature component data (IQ data) (including synchronization signal block (SSB) and reference signal), UL frequency domain IQ data (including a reference signal such as a sounding reference signal) and frequency domain IQ data for a physical random-access channel (PRACH) are transmitted in the U-plane. The information or data can be mixed with the message. The U-plane, also called the data plane, carries the network user traffic. A plane, in a networking context, is one of three integral components of a telecommunications architecture. These three elements are the data plane, the control plane, and the management plane. The user plane protocol stacked between the gNB 100 and the UE 150 consists of the following sub-layers: PDCP (Packet Data Convergence Protocol), RLC (radio Link Control), and Medium Access Control (MAC). The control plane includes the Radio Resource Control layer (RRC) which is responsible for configuring the lower layers.

The O-DU 120 transmits (202) a control (C-plane) message for U-plane data in slot #n to the O-RU 130. The C-plane message is an eCPRI (Enhanced Common Public Radio Interface) message type 2, and transfers allocation information for a section and beamforming information corresponding to each section in 6 section Type messages. A section means an area in which RBs (resource blocks) having the same beam pattern is continuously allocated within one slot, and data of U-plane may be transmitted for each section. In general, one section may include 12 REs (or subcarriers) (that is, 1 resource block (RB)) to 273 RBs on the frequency axis, and may be a rectangle having 1 symbol to 14 symbols on the time axis. One section may include contiguous or non-contiguous allocations. If the beams applied within the 12 REs (1RB) are different, one section may be divided according to a plurality of RE masks having different bit patterns.

Six types of section types can be supported as follows:

Section Type=0: This indicates a DL idle/guard period, which is for transmission blanking for power saving.

Section Type=1: This is used to map a beamforming index or weight to REs of DL and UL channels, which is a beamforming method that is supported mandatorily in O-RAN.

Section Type=3: This is used to map a beamforming index or weight to the RE of a channel in which PRACH and numerology are mixed (mixed-numerology).

Section Type=5: This is used to deliver UE scheduling information so that the RU can calculate real-time beamforming weights, which is a beamforming method that is optionally supported in O-RAN.

Section Type=6: This is used to periodically transmit UE channel information so that the RU can calculate the real-time beamforming weight, which is a beamforming method that is optionally supported in the O-RAN.

Section Type=7: This is used for LAA (licensed assisted access) support.

The O-DU 120 transmitting the C-plane message transmits (204, 206, and 208) IQ data for each OFDM symbol in slot #n as a U-plane message. The U-Plane message transfers IQ data (and the reference signal, SSB) and PRACH IQ data for a user using eCPRI message type 0. There are two data formats in the U-plane data. In the case of DL/UL user data and static data format, the IQ format and compression method are fixed, and the IQ format and compression method are configured by the M-Plane message at the RU initialization time. In the case of DL/UL user data and dynamic data format, the IQ format and compression method may be dynamically changed, which is configured by a DL U-Plane message and a UL C-Plane message.

Thereafter, the O-DU 120 transmits (210) a C-plane message for U-plane data in slot #n+1 to the O-RU 130. Thereafter, the O-DU 120 transmits (212, 214 and 216) IQ data for each OFDM symbol of slot #n+1 to the O-RU 130 as a U-plane message.

Although FIG. 2 illustrates the case of DL transmission, the UL transmission may be performed similarly.

In the case of spatial multiplexing, number of TRX radio modules 134 are equal to the maximum no. of layers supported by O-RU 130. Referring back to FIG. 1 and in conjunction with FIG. 2, when no UE 150 is served by any particular cell, it is only some common channel and signal (i.e., may be referred to as base data or limited system information such as for example, SSB/MIB data/SIB-1/PDCCH/PCH data) that needs to be transmitted in DL data frame. For example, in this case, DL data frame carries only IQ data related to said limited system information.

In case, if the data carried by said DL data frame for a TRX module-1 is less than the base data and first predefined data transmission i.e., threshold-1 and for other TRX module-2 is less than second predefined data transmission i.e., threshold-2 for the defined time period (Tx), then the O-RU 130 may conclude that no attached user is in spatial multiplexing mode. Hence unused TRX module power can be reduced by feedback to said PA 134-3.

The power reduction of said unused TRX module can be identified by said O-RU 130 by calculating the size of the first DL data frame to be processed using each TRX radio module 134 during a first predefined time period (Tx1). Further, O-RU 130 may be configured to calculate the size of a second DL data frame to be processed using each TRX radio module 134 during a second predefined time period (Tx2). The second predefined time period is greater than or equal to said first predefined time period. Further, the O-RU 130 may be configured to periodically change said the power of at least one TRX radio module 134 based on said size of said first DL data frame and said size of said second DL data frame.

For example, the size of said DL data frame for PBCH configuration may be calculated as:
FR1; up to 8 Beam
Total bits in MIB=23
Bit for BCCH type=1 BCCH-BCH is made of one choice parameter out of two elements (MIB or message Class Extension)
Total MIB bits=24
Additional timing payload=8(4+1+3)
4=LSB of SFN
1=Half Frame bit
3=SS Block time index for FR2 OR 1 extra bit for CRB grid offset (Kssb), remaining 2 are reserved

Note: Remaining 3 bits of SS Block are achieved by changing the DMRS sequence
CRC bits=24
Total=56 bits
Polar Coding (Coding rate=11/100=0.11→Total Bits=512
Rate Matching=864 bits
QPSK modulation=432 symbols
RS in PBCH=144
Remaining RE in PBCH=576−144=432
PBCH Total size=240+240+48+48=576 RE.

Hence, the size of DL frame of said PBCH=576 IQ samples.

TABLE 1

| Parameter Name | Values | Number of Bits |
|---|---|---|
| System Frame Number | bit string | 6 |
| Sub Carrier Spacing | scs15or60, | 1 |
| Common | scs30or120 | |
| ssbSub Carrier Offset | 0 to 15 | 4 |
| dmrs Type Aposition | pos2, pos3 | 1 |
| pdcchConfigSIB1 | control reset (0 to | 8 |
| | 15), search space | |
| | Zero (0 to 15) | |
| Cell Barred | barred, not Barred | 1 |
| intra Freq Reselection | allowed, not | 1 |
| | Allowed | |
| Spare | bit string | 1 |
| Total Bits | | 23 |

In the above case, the O-RU 130 may be configured to periodically lower said the power of said at least one TRX radio module 134, when said size of said first DL data frame is equal to said size of said second DL data frame.

Alternatively, the O-RU 130 may be configured to periodically increase said power of said at least one TRX radio module 134, when said size of said first DL data frame is less than said size of said second DL data frame.

Unlike to conventional mechanism, the present disclosure provides a mechanism implemented with said O-RU 130 for reducing and/or optimizing the power consumption within said O-RU 130, without command from other network elements such as for example, O-DU 120 and O-CU.

Furthermore, the power reduction of said unused TRX module can be identified by said O-RU 130 by calculating a size of said DL data frame to be processed using each TRX radio module 134. In this case, the O-RU 130 may be configured to determine whether said size of DL data frame for each TRX radio module 134 meets a predefined data transmission threshold (e.g., threshold-1 and threshold-2, as discussed above). Furthermore, said O-RU 130 may be configured to periodically change said the power of said at least one TRX radio module 134 at predetermined time intervals (Tx1 and Tx2, as discussed above) in response to determining that said size of DL data frame for each TRX module 134 meets said predefined data transmission threshold.

The O-RU 130 may periodically lower the power of said at least one TRX radio module 134 at said predetermined time intervals in response to determining that said size of DL data frame for each TRX module 134 meets said predefined data transmission threshold.

Alternatively, the O-RU 130 may periodically increase the power of said at least one TRX radio module 134 at said predetermined time intervals in response to determining that said size of DL data frame for each TRX module 134 fails to meet said predefined data transmission threshold.

However, once the data is transmitted via any TRX radio module 134 is more than said predefined data transmission threshold (i.e., threshold3), the O-RU 130 may be configured to remove the power capping (i.e., MaxRedPower or MaxIncPower) would be removed and all TRX radio modules 134 may be allowed to transmit the data with normal/default power.

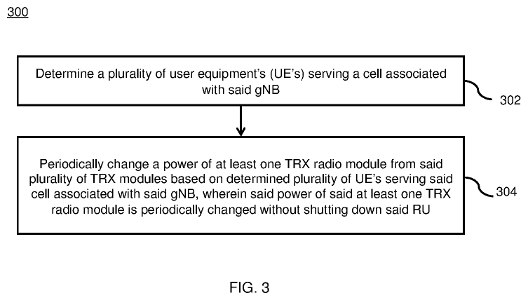

FIG. 3 illustrates a flowchart 300 of the power management method for the O-RU 130 of the gNB 100 operating in the wireless communication network. It may be noted that in order to explain the method steps of the flowchart 300, references will be made to the elements explained in FIG. 1 and FIG. 2.

At step 302, the power management method includes determining the plurality of user equipment's (UE's) 150 serving the cell associated with said gNB 100. At step 304, the power management method includes periodically changing the power of at least one TRX radio module from said plurality of TRX modules 134 based on the determined plurality of UE's 150 serving said cell associated with said gNB 100, where said the power of said at least one TRX radio module is periodically changed without shutting down said O-RU 130.

It may be noted that flowchart 300 is explained to have above stated process steps; however, those skilled in the art would appreciate that flowchart 300 may have more/less number of process steps which may enable all the above stated implementations of the present disclosure.

The various actions act, blocks, steps, or the like in the flow chart 300 may be performed in the order presented, in a different order or simultaneously. Further, in some implementations, some of the actions, acts, blocks, steps, or the like may be omitted, added, modified, skipped, or the like without departing from the scope of the present disclosure.

Advantageously, the present disclosure helps to reduce the OPEX, reduce the interference and further boost the network capacity. The present disclosure can have good OPEX savings for every mobile network provider as if there is no traffic the power can be saved.

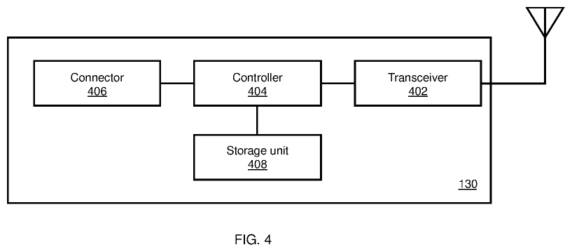

FIG. 4 illustrates various hardware elements of said O-RU 130 of the gNB (or base station) 100, according to the present disclosure.

Referring to FIG. 4, various hardware elements of said O-RU 130 of the base station 100 includes a transceiver 402, at least one processor and/or controller 404, a connector 406, and a storage unit 408. However, the components of the O-RU 130 of the base station are not limited to the above-described example, and for example, the O-RU 130 of the base station may include more or fewer components than the illustrated components. In addition, the transceiver 402, the storage unit 408, and the controller 404 may be implemented in the form of a single chip.

The transceiver 402 may transmit and receive signals to and from a terminal i.e., the UE. Here, the signal may include control information and data. To this end, the transceiver 402 may include an RF transmitter that upconverts and amplifies a frequency of a transmitted signal, and an RF receiver that amplifies a received signal with low noise and down converts a frequency. Alternatively, the RF transmitter and RF receiver, of sad transceiver 402, may together be referred to as said TRX radio module. However, this is only an example component of the transceiver 402, and components of the transceiver 402 are not limited to the RF transmitter and the RF receiver. In addition, the transceiver 402 may receive a signal through a wireless channel, output the same to the controller 404, and transmit the signal output from the controller 404 through a wireless channel. In addition, the transceiver 402 may separately include an RF transceiver for an LTE system and an RF transceiver for an NR system or may perform physical layer processing of LTE and NR with one transceiver.

Storage unit 408 may store programs and data necessary for the operation of the RU of the base station. In addition, storage unit 408 may store control information or data included in signals transmitted and received by the RU device of the base station. The storage unit 408 may be composed of a storage medium such as read only memory (ROM), random access memory (RAM), hard disk, compact disc ROM (CD-ROM), and digital versatile disc (DVD), or a combination of storage media. Also, there may be a plurality of storage units 408.

The controller 404 may control a series of processes so that the O-RU 130 of the base station (gNB 100) can operate according to the description described above. For example, the controller 404 may transmit/receive an LTE (Long-Term Evolution) or NR (New Radio) signal to and from the terminal according to a C-plane message and a U-plane message received from the O-DU 120 of the base station through the connector 406. There may be a plurality of controllers 404, and the controller 404 may perform a component control operation of the O-RU 130 of the base station by executing a program stored in the storage unit 408.

The controller 404 may be configured to control and to receive a control message including multimedia broadcast multicast service single frequency network (MBSFN)-related information for a subframe from a digital unit of a base station through the connector (or connection unit) 406 to be described later.

The connector 406 is a device that connects the O-RU 130 of the base station and the O-DU 120 of the base station and may perform physical layer processing for message transmission and reception, transmit a message to the O-DU 120 of the base station, and receive a message from the O-DU 120 of the base station.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repositories, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A power management method for a radio unit (RU) of a next generation NodeB (gNB) operating in a wireless communication network, wherein said RU comprising a plurality of transmitter and receiver (TRX) radio modules for data processing, the method comprising:
determining a plurality of user equipment's (UE's) served by cell associated with said gNB; and
periodically changing power of at least one TRX radio module from said plurality of TRX modules based on the determined plurality of UE's serving said cell associated with said gNB, wherein said the power of said at least one TRX radio module is periodically changed without shutting down said RU.

2. The power management method as claimed in claim 1, wherein periodically changing said power of said at least one TRX radio module comprises:
periodically reducing the power of said at least one TRX radio module, in response to determining that no UE is served by said cell associated with said gNB for a predefined time period.

3. The power management method as claimed in claim 1, wherein periodically changing said power of said at least one TRX radio module comprises:
periodically increasing said power of said at least one TRX radio module, in response to determine that at least one UE is served by said cell associated with said gNB for said predefined time period.

4. The power management method as claimed in claim 1, wherein periodically changing said power of said at least one TRX radio module comprising:
calculating a size of a first downlink (DL) data frame to be processed using each TRX radio module, from said plurality of TRX radio modules, during a first predefined time period;
calculating a size of a second downlink (DL) data frame to be processed using each of TRX radio module, from said plurality of TRX radio modules, during a second predefined time period, wherein said second predefined time period is greater than or equal to said first predefined time period and wherein said first downlink (DL) data frame and second downlink (DL) data frame comprises a system information; and
periodically changing said power of at least one TRX radio module from said plurality of TRX modules based on said size of said first downlink (DL) data frame and said size of said second downlink (DL) data frame.

5. The power management method as claimed in claim 1, wherein periodically changing said power of at least one TRX radio module from said plurality of TRX modules based on said size of said first downlink (DL) data frame and said the size of said second downlink (DL) data frame comprises:
restoring the periodically changing said power of at least one TRX radio module from said plurality of TRX modules based on said size of said first downlink (DL) data frame and said size of said second downlink (DL) data frame.

6. The power management method as claimed in claim 4, wherein periodically changing said power of at least one TRX radio module from said plurality of TRX modules based on said size of said first downlink (DL) data frame and said the size of said second downlink (DL) data frame comprises:
periodically lowering said power of said at least one TRX radio module, when said size of said first downlink (DL) data frame is equal to said size of said second downlink (DL) data frame.

7. The power management method as claimed in claim 4, wherein periodically changing said power of at least one TRX radio module from said plurality of TRX modules based on said size of said first downlink (DL) data frame and said size of said second downlink (DL) data frame comprises:
periodically increasing said power of said at least one TRX radio module, when said size of said first downlink (DL) data frame is less than said size of said second downlink (DL) data frame.

8. The power management method as claimed in claim 1, wherein periodically changing said power of said at least one TRX radio module by said power management unit comprises:
calculating a size of a downlink (DL) data frame to be processed using each TRX radio module, wherein said DL data frame comprises system information;
determining whether said size of DL data frame for each TRX radio module meets a predefined data transmission threshold; and
periodically changing said power of said at least one TRX radio module at a predetermined time intervals in response to determining that said size of DL data frame for each TRX module from said plurality of TRX radio modules meets said predefined data transmission threshold.

9. The power management method as claimed in claim 7, wherein said periodically changing said power of said at least one TRX radio module at said predetermined time intervals in response to determining that said size of DL data frame for each TRX module from said plurality of TRX radio modules meet said predefined data transmission threshold comprises:
periodically lowering said power of said at least one TRX radio module at said predetermined time intervals in response to determining that said size of DL data frame for each TRX module from said plurality of TRX radio modules meets said predefined data transmission threshold.

10. The power management method as claimed in claim 7, wherein said periodically changing said power of said at least one TRX radio module at said predetermined time intervals in response to determining that said size of DL data frame for each TRX module from said plurality of TRX radio modules meet said predefined data transmission threshold comprises:
periodically increasing said the power of said at least one TRX radio module at said predetermined time intervals in response to determining that said size of DL data frame for each TRX module from said plurality of TRX radio modules fails to meet said predefined data transmission threshold.

11. The power management method as claimed in claim 4, wherein said DL data frame is associated with a user plane function comprising in phase and quadrature phase (IQ) samples and wherein said system information comprises data associated with at least one of SSB (Synchronization Signal Block), MIB (Master Information Block), SIB-1 (System Information Block #1), PDCCH (physical downlink control channel) and PCH (Paging Channel).

12. A radio unit (RU) of a next generation NodeB (gNB) operating in a wireless communication network, wherein said RU comprising a plurality of transmitter and receiver (TRX) radio modules for data processing, the RU, comprising:
a connector configured to transmit and receive data between said RU and a distributed unit (DU), and
a controller configured to:
determine a plurality of user equipment's (UE's) served by a cell associated with said gNB; and
periodically change the power of at least one TRX radio module from said plurality of TRX modules based on the determined plurality of UE's served by said cell associated with said gNB, wherein said the power of said at least one TRX radio module is periodically changed without shutting down said RU.

13. The RU as claimed in claim 12, wherein periodically changing said power of said at least one TRX radio module by said controller comprising:
periodically reducing the power of said at least one TRX radio module, in response to determining that no UE is served by said cell associated with said gNB for a predefined time period.

14. The RU as claimed in claim 12, wherein periodically changing said power of said at least one TRX radio module by said controller comprising:
periodically increasing said power of said at least one TRX radio module, in response to determine that at least one UE is served by said cell associated with said gNB for said predefined time period.

15. The RU as claimed in claim 12, wherein periodically changing said power of said at least one TRX radio module by said controller comprising:
calculating a size of a first downlink (DL) data frame to be processed using each TRX radio module, from said plurality of TRX radio modules, during a first predefined time period;
calculating a size of a second downlink (DL) data frame to be processed using each of TRX radio module, from said plurality of TRX radio modules, during a second predefined time period, wherein said second predefined time period is greater than or equal to said first predefined time period and wherein said first downlink (DL) data frame and second downlink (DL) data frame comprises a system information; and
periodically changing said power of at least one TRX radio module from said plurality of TRX modules based on said size of said first downlink (DL) data frame and said size of said second downlink (DL) data frame.

16. The RU as claimed in claim 14, wherein periodically changing said power of at least one TRX radio module from said plurality of TRX modules based on said size of said first downlink (DL) data frame and said size of said second downlink (DL) data frame comprises:
periodically lowering said power of said at least one TRX radio module, when said size of said first downlink (DL) data frame is equal to said size of said second downlink (DL) data frame.

17. The RU as claimed in claim 14, wherein periodically changing said power of at least one TRX radio module from said plurality of TRX modules based on said size of said first downlink (DL) data frame and said size of said second downlink (DL) data frame comprises:
periodically increasing said power of said at least one TRX radio module, when said size of said first downlink (DL) data frame is less than said size of said second downlink (DL) data frame.

18. The RU as claimed in claim 12, wherein periodically change said the power of said at least one TRX radio module by said controller:
calculating a size of a downlink (DL) data frame to be processed using each TRX radio module, wherein said DL data frame comprises system information;
determining whether said size of DL data frame for each TRX radio module meets a predefined data transmission threshold; and
periodically changing said power of said at least one TRX radio module at a predetermined time intervals in response to determining that said size of DL data frame for each TRX module from said plurality of TRX radio modules meets said predefined data transmission threshold.

19. The RU as claimed in claim 17, wherein said periodically changing said power of said at least one TRX radio module at said predetermined time intervals in response to determining that said size of DL data frame for each TRX module from said plurality of TRX radio modules meet said predefined data transmission threshold comprises:
periodically lowering said power of said at least one TRX radio module at said predetermined time intervals in response to determining that said size of DL data frame for each TRX module from said plurality of TRX radio modules meet said predefined data transmission threshold.

20. The RU as claimed in claim 17, wherein said periodically changing said power of said at least one TRX radio module at said predetermined time intervals in response to determining that said size of DL data frame for each TRX module from said plurality of TRX radio modules meet said predefined data transmission threshold comprises:
periodically increasing said the power of said at least one TRX radio module at said predetermined time intervals in response to determining that said size of DL data frame for each TRX module from said plurality of TRX radio modules fails to meet said predefined data transmission threshold.

21. The RU as claimed in claim 15, wherein said DL data frame is associated with a user plane function comprising in phase and quadrature phase (IQ) samples and wherein said system information comprises data associated with at least one of SSB (Synchronization Signal Block), MIB (Master Information Block), SIB-1 (System Information Block #1), PDCCH (physical downlink control channel) and PCH (Paging Channel).
